(19) United States
(12) Patent Application Publication
(10) Pub. No.: US 2011/0069687 A1
(43) Pub. Date: Mar. 24, 2011

(54) Wireless Broadband Deployment

(75) Inventors: Behrooz Rezvani, San Ramon, CA (US); Saied Ansari, Oakland, CA (US)

(73) Assignee: Quantenna Communications, Inc., Fremont, CA (US)

(21) Appl. No.: 12/840,252

(22) Filed: Jul. 20, 2010

Related U.S. Application Data
(60) Provisional application No. 61/227,053, filed on Jul. 20, 2009.

(51) Int. Cl. H04W 40/00

(52) U.S. Cl. 370/338

(57) ABSTRACT

Deployment of wireless broadband and systems for use in providing wireless broadband is described. The system can include a trunk, which can include a root node, optional repeaters, and a main distribution node, the combination which enables wireless MIMO backhaul to a network such as the Internet.

### CROSS-REFERENCE TO RELATED APPLICATIONS

The present application claims priority to U.S. Provisional Patent App. No. 61/227,053, filed on Jul. 20, 2009, which is incorporated by reference.

### BACKGROUND

A wireless network generally includes a network architecture and set of protocols to route data between wireless nodes in the network, often using intermediate nodes as relays in multi-hop routing. Mesh networking typically adjusts the routes between nodes to get around broken, blocked, or poorly performing links along the path between the source and destination node. In particular, mesh networks are self-healing: the network can still operate even when a node breaks down or a connection goes bad. As a result, a reliable network can be formed. Many different neighbor discovery and routing algorithms have been used in mesh networks. These algorithms generally do not take into account multiple antennas at each node with multiple frequency bands that a given node may have access to. State-of-the-art information (as of 2005) regarding wireless communications, including neighbor discovery and routing protocols, can be found in the book Wireless Communications by Andrea Goldsmith, which is incorporated by reference. Areas of ongoing research include, for example, implementing multiple input multiple output (MIMO) technologies, providing an outdoor deployment of broadband networks that are compatible with IEEE 802.11 and other wireless standards.

The foregoing examples of the related art are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

Deployment of wireless broadband and systems for use in providing wireless broadband is described. The system can be implemented indoors or outside. In a specific implementation, the system takes advantage of 4×4 multiple-input multiple-output (MIMO) technology and techniques. The system can also or instead take advantage of some other (e.g., 8×8 MIMO) technology and techniques. With appropriate configuration, the system enables industry-leading reliability, at least with respect to packet error rate (PER). The system can include a trunk, which can include a root node, optional repeaters, and a main distribution node, the combination which enables wireless MIMO backhaul to a network such as the Internet. In general, any applicable transmission medium from a main distribution node to point of presence (PoP) or head end can be considered a trunk.

Components of the system include wireless devices. Generic modular units can be implemented “in parallel” for wireless backhaul in a wireless network or on their own for distribution. An optional goal of component design can be system in a package (SiP), though a two chip package, one for radio frequency (RF) and one for baseband, is also a design choice. Advantageously, the wireless devices can use 4×4 MIMO technologies to accomplish digital beamforming and other tasks.

The description in this paper describes this technique and examples of systems implementing this technique.

### BRIEF DESCRIPTION OF THE DRAWINGS

Examples of the claimed subject matter are illustrated in the figures.

FIG. 1 depicts an example of a wireless multiple-input multiple-output (MIMO) backhaul and distribution system.

FIG. 2 depicts a computer system that can be used in the wireless MIMO backhaul and distribution system of FIG. 1.

FIG. 3 depicts an example of an N×M generic modular system.

FIG. 4 depicts an example of a point-to-point wireless relay node.

FIG. 5 depicts an example of an AP that is part of a wireless MIMO backhaul network.

FIG. 6 depicts a flowchart of an example of a method for providing a wireless distribution network.

### DETAILED DESCRIPTION

In the following description, several specific details are presented to provide a thorough understanding of examples of the claimed subject matter. One skilled in the relevant art will recognize, however, that one or more of the specific details can be eliminated or combined with other components, etc. In other instances, well-known implementations or operations are not shown or described in detail to avoid obscuring aspects of the claimed subject matter.

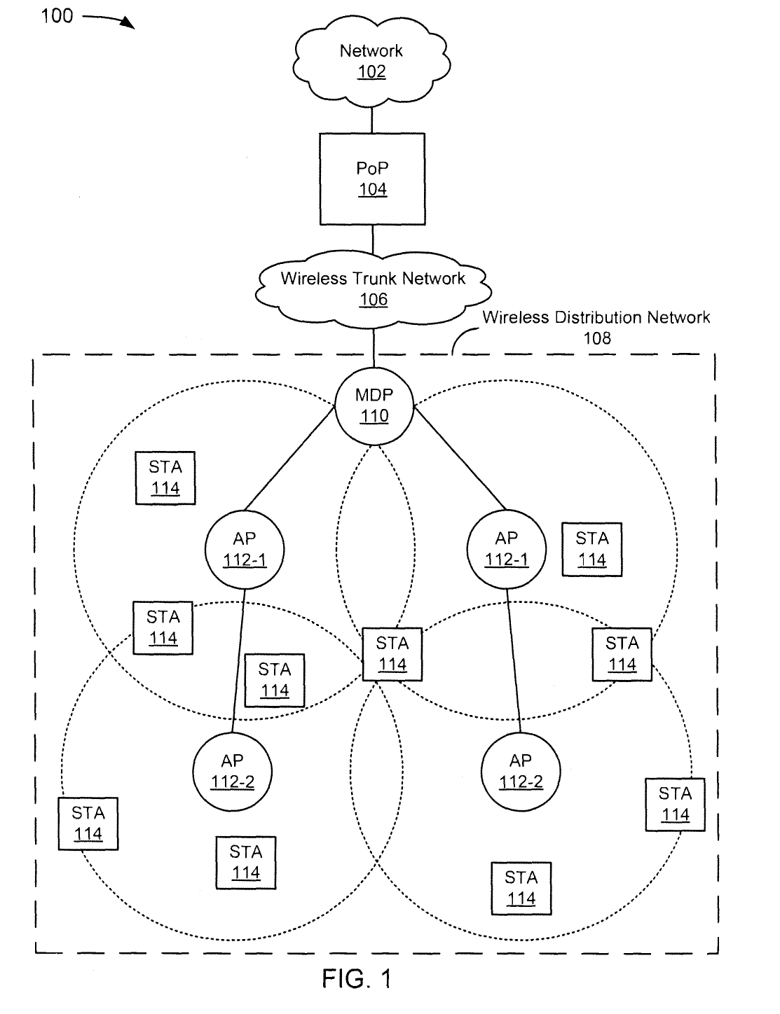

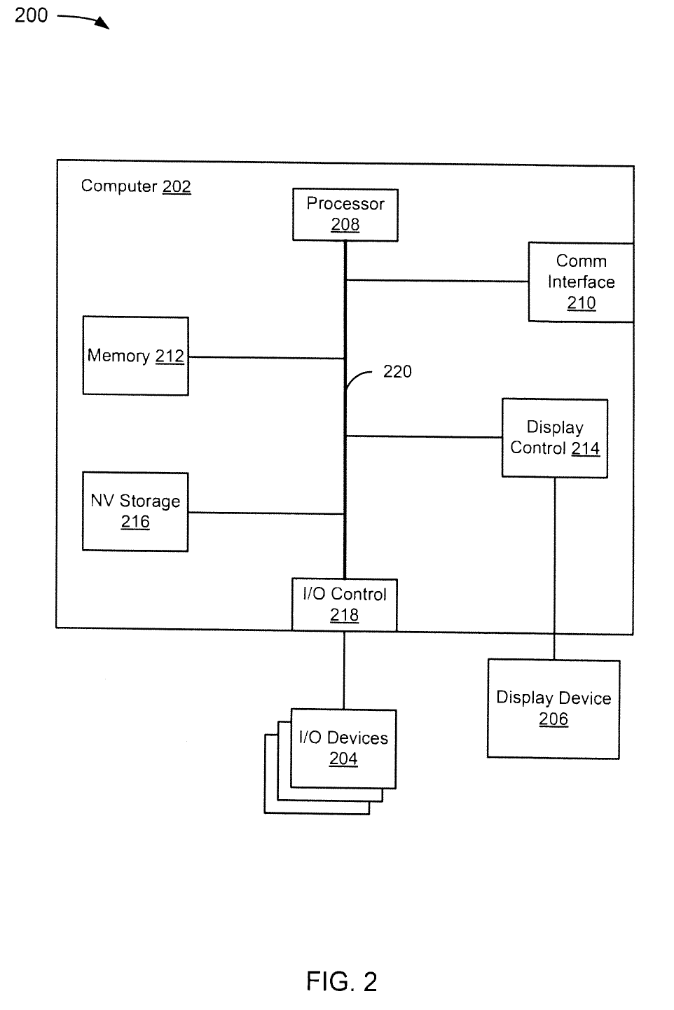

FIG. 1 depicts an example of a wireless multiple-input multiple-output (MIMO) backhaul and distribution system 100. The system 100 includes network 102, a point of presence (PoP) 104, a wireless trunk network 106, and a wireless distribution network 108. A computer system that can be used in the system 100 is described later with reference to FIG. 2.

In the example of FIG. 1, the network 102 may be practically any type of communications network. In an implementation that provides wireless broadband to population centers, the network 102 is likely to include the Internet. The term “broadband” is a relative term. For example, broadband Internet access is typically contrasted with dial-up access using a 56k modem. In a specific implementation, the term broadband can be used to mean at least equivalent to a digital subscriber line (DSL), which is about 70 Mbps. For example, 70 Mbps could include 6 Mbps of Internet access, 30 Mbps of broadcast video, and 35 Mbps of switched digital video (give or take). In Ethernet provided over cable modem is a common alternative to DSL; and the term broadband should be interpreted to mean equivalent to that of 100BASE-T Ethernet, as well. In telecommunication, a very narrow band can carry Morse code, a narrow band will carry speech (voiceband), and a still broader band will carry real-time multimedia. Only the latter would normally be considered “broadband.” However, it may be noted that a voice line could be converted to a non-laded twisted-pair wire (no telephone filters) to become hundreds of kilohertz wide (broadband) and can carry several Mbps. Thus, the term broadband in this paper should include equivalent to ADSL, which, depending upon the implemented standard can be from 2 Mpbs to 27.5 Mbps. As another example, digital signal 3 (DS3) is a digital signal level 3 T-carrier, also referred to as a T3 line, with a data rate of 44.736 Mpbs, which would be considered in the “broadband” range. Currently, a sophisticated consumer expectation for broadband range for Internet access would be perhaps 44 Mbps or higher, or perhaps approximately 70-100 Mbps, but it should be understood that the definition of broadband could change over time to include different, presumably higher, Mbps than those just described, and different consumer expectations.

In the example of FIG. 1, the PoP 104 includes an access point to the network 102. The term “PoP” is frequently used with reference to an access point to the Internet, but is used more broadly in this paper to mean an access point to the network 102. In a typical implementation, the PoP 104 could include servers, routers, ATM switches, digital/analog call aggregators, etc. The PoP 104 can be part of the facilities of a telecommunications provider that an Internet service provider (ISP) rents or a location separate from a telecommunications provider. The PoP 104 can be referred to as “on” the network 102.

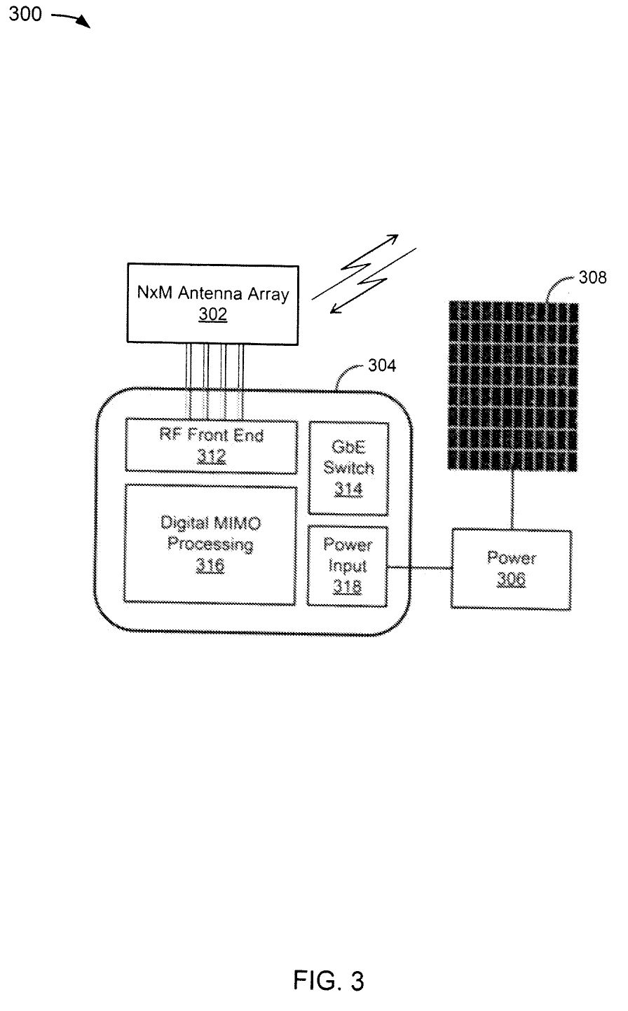

In the example of FIG. 1, the wireless trunk network 106 includes a set of point-to-point relay nodes that extend from the PoP 104 to the wireless distribution network 108. The data rate through the wireless trunk network 106 will typically be higher than the broadband access rate provided to non-AP stations of the wireless network. In a specific implementation, the data rate for a trunk network is 3.6 Gbps downstream and 1.2 Gpbs upstream, but this will, of course, vary depending upon the amount of wireless traffic that passes through the wireless trunk network 106. One of skill in the relevant art would likely use a formula based upon the number of residences that receive broadband wireless service. If the size of the trunk needs to be changed after an implementation, advantageously, N×M generic modular units at the relay nodes can be swapped in or out, The N×M generic modular units are described later with reference to FIG. 3.

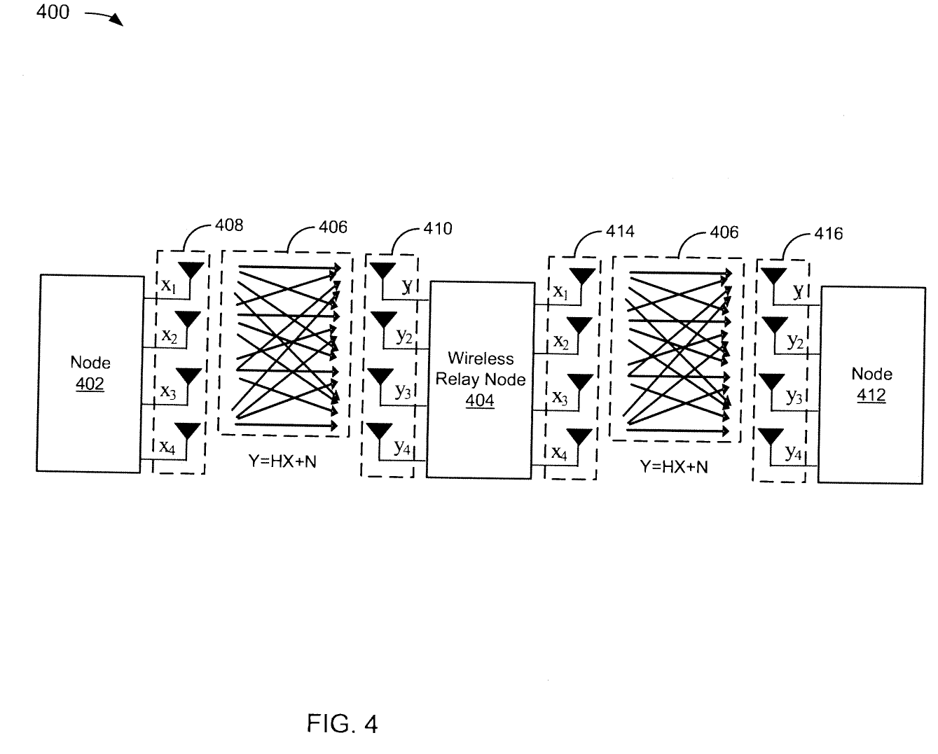

The first relay node in the wireless trunk network 106 is the root node, which can be wire connected to the PoP 104. Zero or more relay nodes are wirelessly connected in series from the root node to the last relay node in the wireless trunk network 106, which can be wirelessly connected to the wireless distribution network 108. A point-to-point relay node is described later with reference to FIG. 4.

In the example of FIG. 1, the wireless distribution network 108 includes a main distribution point (MDP) 110, access points (APs) 112-1 to 112-2 (referred to collectively as APs 112), and zero or more stations 114. For illustrative simplicity, it is assumed that there is at least one station 112 per AP 110, but one of skill in the relevant art would understand that an AP need not have any associated stations at any given time. A station, as used in this paper, may be referred to as a device with a media access control (MAC) address and a physical layer (PHY) interface to a wireless medium that complies with the IEEE 802.11 standard. In alternative embodiments, a station may comply with a different standard than IEEE 802.11, or no standard at all, may be referred to as something other than a “station,” and may have different interfaces to a wireless or other medium. IEEE 802.11a-1999, IEEE 802.11b-1999, IEEE 802.11g-2003, IEEE 802.11-2007, and IEEE 802.11n TGn Draft 8.0 (2009) are incorporated by reference. As used in this paper, a system that is 802.11 standards-compatible or 802.11 standards-compliant complies with at least some of one or more of the incorporated documents' requirements and/or recommendations, or requirements and/or recommendations from earlier drafts of the documents.

Thus, the APs 112 can be referred to as stations, if applicable. In alternative embodiments, a station may comply with a different standard than IEEE 802.11, may be referred to as something other than a “station,” and may have different interfaces to a wireless or other medium. An implementation of the wireless distribution network 108 has been referred to as a wireless PON (WPON) for marketing purposes. It may be noted that the acronym PON is not intended to have the technical meaning it is given in the optical arts because a WPON is not really a wireless “passive optical network.”

In the example of FIG. 1, the MDP 110 includes a point-to-multipoint MIMO system. Electronic traffic to the wireless distribution network 108 from the network 102 passes through the MDP 110, and vice versa. The MDP 110 is depicted as inside the wireless distribution network 108 in the example of FIG. 1, but it should be noted that the MDP 110 could be depicted as between the wireless distribution network 108 and the wireless trunk network 106. Thus, it could alternatively be said that the system 100 includes the wireless distribution network 108 and the MDP 110 even though FIG. 1 makes that phrase appear to redundantly include the MDP 110. The distinction is not critical to an understanding of the techniques, however.

In the example of FIG. 1, the APs 112 are stations that have backhaul functionality. As with the wireless trunk network 108 bandwidth requirements, it is not possible to state how much bandwidth each of the APs 112 will need until the load is known or predicted, which can be based upon the types of users, the number of stations, and, potentially, where in the backhaul chain an AP lies, all of which can be factors in determining expected load.

In the example of FIG. 1, the stations 114 are non-AP stations that are coupled to the wireless distribution network through one of the APs 112. For illustrative purposes, the APs 112 are designated 112-1 for APs that are one hop from the MDP 110, 112-2 for APs that are two hops from the MDP 110, and in general 112-N (not shown) for APs that are N hops from the MDP 110. The distance of an AP 112-N from the MDP 110 may have some bearing upon the amount of bandwidth the AP needs for backhaul, since each additional hop can result in additional load (more stations) on the network.

FIG. 1 can include a matrix mesh network. In the example of FIG. 1, if implemented with a matrix mesh network, matrix mesh elements are nodes within the wireless distribution network 108. A mesh is not a “matrix mesh” unless at least one node has multiple antennas. Accordingly, at least one of the matrix mesh elements must have multiple antennas, or at least an antenna with multi-antenna functionality. The matrix mesh elements may or may not include data of their own, but a system can take advantage of matrix mesh element network characteristics in network architecture and/or protocols. In this way, the system can adapt to traffic and/or network demands by optimizing end-to-end transmissions from a client, through at least one of the matrix mesh elements, to a client. One implementation of a matrix mesh network is the VECTOR MESH™ network of Quantenna Communications, Inc. of Sunnyvale, Calif. The VECTOR MESH™ network includes VECTOR MESH™ elements or nodes, and a VECTOR MESH™ network architecture, neighbor discovery protocol, and routing protocol.

An advantage of implementing a matrix mesh network is that APs trying to reach multiple stations, 3 out of 4 streams could get knocked out and the system would still work. Different streams can survive to get to different stations. It has been shown in a proof of concept that MIMO is more reliable outside than SISO, and can survive seasonal changes to the environment, such as the elements and foliage growing into the wireless transmission path. In a successful test, poles were placed at between 120 and 170 feet, with intervening obstacles including a thick exterior wall and big trees blocking. The access point locations were approximately 5 feet above the ground, and were operated in the 5 GHz band. The average UDP data rate was 110-120 Mbps and the wireless link rate was 180-200 Mbps. Existing systems have much lower data rates than the proof of concept had.

FIG. 2 depicts a computer system 200 that can be used in the system 100 (FIG. 1). The computer system 200 may be a conventional computer system that can be used as a client computer system, such as a wireless client or a workstation, or a server computer system. The computer system 200 includes a computer 202, I/O devices 204, and a display device 206. The computer 202 includes a processor 208, a communications interface 210, memory 212, display controller 214, non-volatile storage 216, and I/O controller 218. The computer 202 may be coupled to or include the I/O devices 204 and display device 206. Stations, including APs, will not necessarily need all of the components, but will typically include at least the processor 208, the communications interface 210, and the memory 212.

The computer 202 interfaces to external systems through the communications interface 210, which may include a radio interface, network interface, or modem. It will be appreciated that the communications interface 210 can be considered to be part of the computer system 200 or a part of the computer 202. The communications interface 210 can include a radio, an analog modem, ISDN modem, cable modem, token ring interface, satellite transmission interface (e.g. “direct PC”), or other interfaces for coupling a computer system to other computer systems.

The processor 208 may be, for example, a conventional microprocessor such as an Intel Pentium microprocessor or Motorola power PC microprocessor. The memory 212 is coupled to the processor 208 by a bus 220. The memory 212 can be Dynamic Random Access Memory (DRAM) and can also include Static RAM (SRAM). The bus 220 couples the processor 208 to the memory 212, also to the non-volatile storage 216, to the display controller 214, and to the I/O controller 218.

The I/O devices 204 can include a keyboard, disk drives, printers, a scanner, and other input and output devices, including a mouse or other pointing device. The display controller 214 may control in the conventional manner a display on the display device 206, which can be, for example, a cathode ray tube (CRT) or liquid crystal display (LCD). The display controller 214 and the I/O controller 218 can be implemented with conventional well known technology.

The non-volatile storage 216 is often a magnetic hard disk, an optical disk, or another form of storage for large amounts of data. Some of this data is often written, by a direct memory access process, into memory 212 during execution of software in the computer 202. In general, an engine implemented in the system 200 can include a dedicated or shared processor and, hardware, firmware, or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The computer system 200 is one example of many possible computer systems which have different architectures. For example, personal computers based on an Intel microprocessor often have multiple buses, one of which can be an I/O bus for the peripherals and one that directly connects the processor 208 and the memory 212 (often referred to as a memory bus). The buses are connected together through bridge components that perform any necessary translation due to differing bus protocols.

Network computers are another type of computer system that can be used in conjunction with the teachings provided herein. Network computers do not usually include a hard disk or other mass storage, and the executable programs are loaded from a network connection into the memory 212 for execution by the processor 208. A Web TV system, which is known in the art, is also considered to be a computer system, but it may lack some of the features shown in FIG. 2, such as certain input or output devices. A typical computer system will usually include at least a processor, memory, and a bus coupling the memory to the processor.

In addition, the computer system 200 is controlled by operating system software which includes a file management system, such as a disk operating system, which is part of the operating system software. One example of operating system software with its associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage 216 and causes the processor 208 to execute the various acts required by the operating system to input and output data and to store data in memory, including storing files on the non-volatile storage 216.

Some portions of the detailed description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Systems described in this paper may be implemented on any of many possible hardware, firmware, and software systems. Typically, systems such as those described in this paper are implemented in hardware on a silicon chip. Algorithms described in this paper are implemented in hardware, such as by way of example but not limitation RTL code. However, other implementations may be possible. The specific implementation is not critical to an understanding of the techniques and the claimed subject matter.

FIG. 3 depicts an example of an N×M generic modular system 300. The system 300 can be produced efficiently and used separately or in combination with other units. The system 300 is “modular” by virtue of being designed as discrete units.

The system 300 includes an N×M antenna array 302, a system in package (SiP) 304, a power source 306, and an (optional) solar array 308. As used in this paper, a SiP is a number of integrated circuits enclosed in a single package that performs most of the functions of an electronic system, in this case a MIMO station. SiP dies containing integrated circuits can be stacked vertically on a substrate and connected by wires. Slightly less dense multi-chip modules can also be used, which place dies on the same plane; and three-dimensional integrated circuits having stacked silicon dies with conductors running through the die can be used. One advantage of implementing the system 300 in a wireless MIMO backhaul system is that the same unit can be used for each node of the backhaul network. Where it is desirable to have greater bandwidth, additional units can be deployed. The units can be configured to operate in the same frequency both upstream and downstream or to operate in different frequencies in each direction.

In the example of FIG. 3, the N×M antenna array 302 includes one or more antennas. (It may be noted that an array of one antenna is normally not referred to as an “array,” but the distinction is not critical to an understanding of the example.) Where there are multiple antennas in the array, the antennae can be coupled to a common source or load to produce a directive radiation pattern. The spatial relationship can contribute to the directivity of the antennae.

Although the N×M antenna array 302 is depicted as outside of the SiP 304, the antenna array could be implemented in the SiP 304, as well. The SiP 304 includes an RF front end 312, a GbE switch 314, a digital MIMO processing block 316, and a power input block 318. A current implementation provides 0.3 Gbps per unit.

FIG. 4 depicts an example of a point-to-point wireless relay node 400. In the example of FIG. 4, a node 402 has, for illustrative purposes only, four transmit antennas x₁, x₂, x₃, and x₄; and a wireless relay node 404 has, for illustrative purposes only, four receive antennas y₁, y₂, y₃, and y₄. The path from the antennas x_{N} to the antennas y_{M} may be referred to collectively as a MIMO channel 406. It may be noted that the node 402 can also be a wireless relay node, a root node (the last node in the wireless backhaul chain), or an MDP (see, e.g., FIG. 1).

The MIMO channel 406 is characterized by a matrix H with M rows and N columns, where N is the number of antennas at the node 402, and M is the number of antennas at the wireless relay node 404. The matrix H describes the channel gains between all transmit-receive antenna pairs of the two matrix mesh elements, i.e. the matrix element h_{i,j} in the i^{th} row and j^{th} column of H is the channel gain between the j^{th} transmit antenna and the i^{th} receive antenna. The transmitted signal is a vector X=[x₁, . . . x_{N}], where xⱼ is the signal transmitted from the j^{th} antenna of the node 402. The received signal is a vector Y=[y₁, . . . y_{M}], where y is the received signal at the i^{th} antenna of the node 404. The received signal at the i^{th} receive antenna is corrupted by noise and possibly interference nᵢ, and the vector N=[n₁, . . . , n_{M}] describes the noise and interference associated with all receive antennas. The received signal vector Y is characterized by the matrix multiplication Y=HX+N, i.e.

$${y}_{i} = {\sum }_{j = 1}^{N} {h}_{ij} {x}_{j} + {n}_{i} ,$$

so that yᵢ is the sum of signals associated with all transmit signals xⱼ, i=1, . . . , N multiplied by the channel gain h_{i,j} the j^{th} transmit antenna to the i^{th} receiver antenna, plus the additive noise nᵢ associated with the i^{th} receiver antenna.

Depending upon whether there are multiple antennas at a station, in a transmit antenna array, and/or multiple antennas in the receive antenna array, the communication link can be referred to as a MIMO link. It should be noted that multiple-input and single-output (MISO), single-input and multiple-output (SIMO), and single-input and single-output (SISO) are special cases of MIMO. MISO is when the receiver has a single antenna. SIMO is when the transmitter has a single antenna. SISO is when neither the transmitter nor the receiver have multiple antennas. The acronym MIMO could be considered to include the special cases, if applicable. The techniques may also be applicable to multi-user MIMO (MU-MIMO), cooperative MIMO (CO-MIMO), MIMO routing, OFDM-MIMO, or other MIMO technologies. The major consideration with respect to multiple antenna use as it relates to the techniques described in this paper is whether there are multiple antennas at the receiver (MIMO or SIMO) or not (SIMO or SISO). When there are multiple antennas at the receiver, there are typically multiple corresponding RF chains and other components.

The MIMO channel 406 between the wireless relay node 404 transmit antennas 414 and a node 412 receive antennas 416 behaves in a similar fashion. It is not necessarily the case that the number of antennas is the same for the nodes 402, 412. The flow of traffic is in opposite directions for upstream and downstream transmissions. In a typical deployment, there may be a difference between upstream and downstream bandwidth, where downstream bandwidth is often greater than upstream bandwidth.

The multiple antennas between nodes can be used to increase data rates by creating multiple independent channels between the nodes (e.g., via spatial multiplexing): the maximum number of such data paths that can be created is the minimum of N and M. Alternatively, transmitted signals can be combined via transmit diversity or beamforming, and/or the received signals can be combined via receive diversity, which increases link robustness. Also, beamsteering can be done to steer an antenna beam in a given direction, which increases range and/or reduces interference. These techniques are not mutually exclusive, and some antennas can be used for spatial multiplexing, others for diversity, and still others for beamsteering or beamforming.

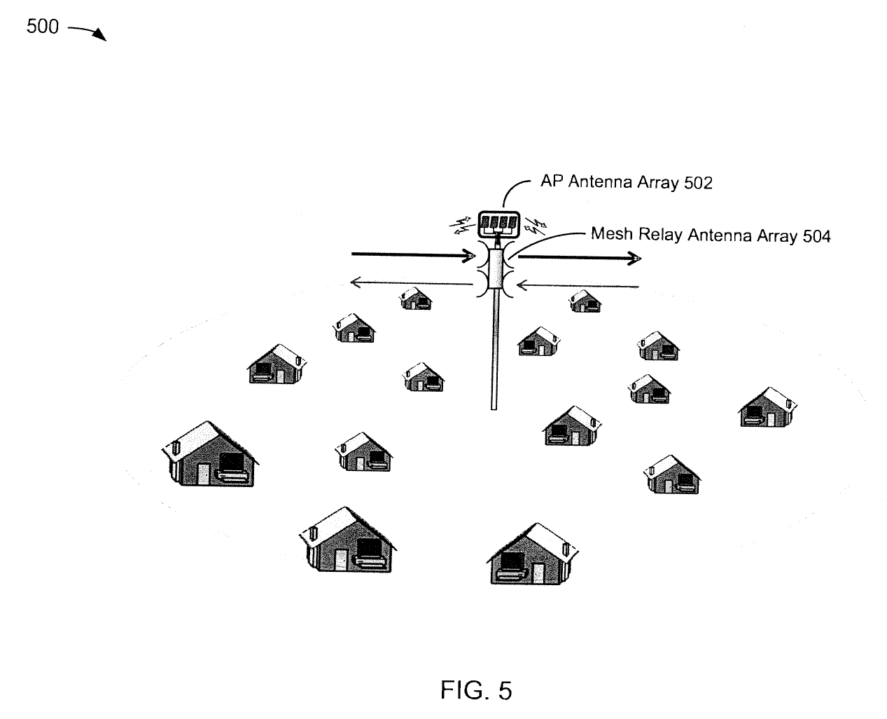

FIG. 5 depicts an example of an AP system 500 that is part of a wireless MIMO backhaul network. FIG. 5 is depicted as providing a wireless distribution network to residences (houses), since providing wireless service to residences is viewed as an advantageous implementation of the technology. Of course, the same techniques could be used for implementation to commercial properties or other stations.

In the example of FIG. 5, the system 500 includes an AP antenna array 502 and a mesh relay antenna array 504. The AP antenna array 502 facilitates wireless communication to stations within range of the AP antenna array. The relevant wireless traffic received on the mesh relay antenna array 504 can be transmitted to the stations. Typically, the wireless traffic that is transmitted to the stations will come in the downstream direction because stations further downstream will typically transmit upstream through to, for example, the Internet. Even for, e.g., email messages from a first station to a station further upstream (but still on the wireless backhaul) will typically be forwarded through the PoP to a relevant server, then sent back downstream to the second station. It may be possible to circumvent this process in order to conserve wireless resources, but that would require a “smart” AP.

Advantageously, deployment of a system, such as described, enables deployment of broadband access that is equivalent to wire. This is made possible by the use of MIMO, which is advantageously less expensive to deploy than wire. While SISO may be cheaper than MIMO to implement, it may not currently be capable of providing access that is equivalent to wire. In an implementation, pole-mounted APs are deployed at 200 meter spacing. Such spacing can be assumed to provide coverage to, for example, 24 homes. With such a spacing and 24 homes within range, it is believed that the cost of deployment can be recouped in 3 years at a cost of about $17.99 per home with 100% penetration. This is a fraction of the cost of deploying wire. The APs need power, of course, but residential indoor and outdoor units would have power supplied by the customer, and pole mounted nodes are expected to have power costs of only $100/year. Power can be supplied using solar panels to eliminate the need to connect backhaul APs to a power grid or the equivalent.

For self-configuration of a matrix mesh network backbone, mesh network elements join the network through a process of neighbor discovery and, once one or more neighbors are found, establishing connections with one or more of these neighbors. Advantageously, due to the longer range and/or better robustness associated with multiple antenna channels, a neighbor discovery protocol designed for a matrix mesh element is likely to be able to establish more robust connections and to identify more neighbors than a discovery algorithm for single-antenna nodes. In an outdoor environment, this can be particularly useful to ensure that not only is the bandwidth associated with the service equivalent to wire, but the reliability also approaches or even matches that of wire.

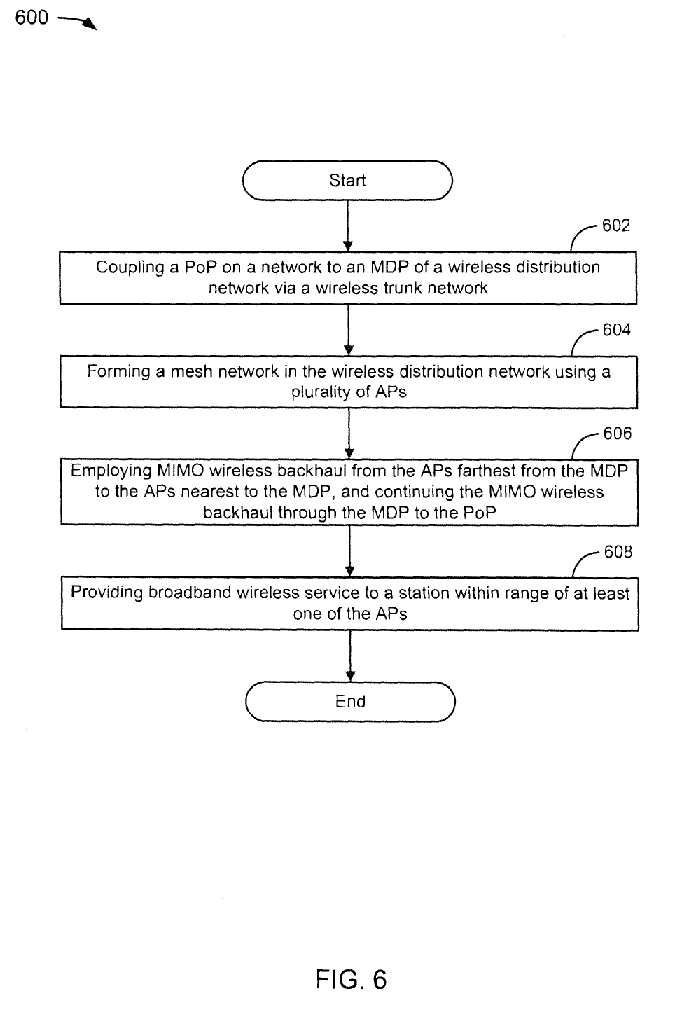

FIG. 6 depicts a flowchart 600 of an example of a method for providing a wireless distribution network. Although this figure depicts functional modules in a particular order for purposes of illustration, the process is not limited to any particular order or arrangement. One skilled in the relevant art will appreciate that the various modules portrayed in this figure could be omitted, rearranged, combined and/or adapted in various ways.

In the example of FIG. 6, the flowchart 600 starts at module 602 with coupling a PoP on a network to an MDP of a wireless distribution network via a wireless trunk network. In a specific implementation, the PoP is on the Internet, though in theory the PoP could be on a network that was not part of the Internet. In a specific implementation, the wireless trunk network is implemented using one or more wireless MIMO relay nodes. Advantageously, the relay nodes can use wireless MIMO backhaul to increase reliability and bandwidth compared to SISO backhaul (a degenerate form of MIMO). When performing the backhaul, it is assumed that the wireless MIMO transmissions are point-to-point from the MDP to and between the relay nodes, if any, and to the root node that is wire coupled to the PoP. It is possible for the root node to be “part of” the PoP, but it can just as easily be conceptually separated. The MDP can be implemented as a point-to-multipoint wireless MIMO AP, though it is assumed that in the upstream direction, when performing wireless backhaul, the transmission is point-to-point.

In the example of FIG. 6, the flowchart 600 continues to module 604 with forming a wireless mesh network in the wireless distribution network using a plurality of APs. Techniques for implementing a mesh network are described by way of example in co-pending patent application Ser. No. 12/278,573, filed Aug. 7, 2008, which is incorporated by reference.

In the example of FIG. 6, the flowchart 600 continues to module 606 with employing MIMO wireless backhaul from the APs farthest from the MDP to the APs nearest to the MDP, and continuing the MIMO wireless backhaul through the MDP to the PoP. It is often useful to measure the distance of an AP from the MDP in units of hops, rather than units of actual distance. However, it will typically be the case that a first AP that needs more hops to reach the MDP than a second AP will also be farther away from the MDP than the second AP in terms of actual distance. In the wireless backhaul direction, the APs will normally transmit point-to-point, though in the downstream direction the APs may transmit either point-to-point or point-to-multipoint.

In the example of FIG. 6, the flowchart 600 ends at module 608 with providing broadband wireless service to a station within range of at least one of the APs. Here, broadband can mean “equivalent to wire.” This high level of bandwidth is attainable, at least in part, because of the use of wireless MIMO techniques, and is particularly advantageous in areas that do not have wire deployed.

Systems described herein may be implemented on any of many possible hardware, firmware, and software systems. Typically, systems such as those described herein are implemented in hardware on a silicon chip. Algorithms described herein are implemented in hardware, such as by way of example but not limitation RTL code. However, other implementations may be possible. The specific implementation is not critical to an understanding of the techniques described herein and the claimed subject matter.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

1. A system comprising:
a wireless trunk network root node coupled to a point of presence (PoP) on a network;
a main distribution point (MDP) coupled to the wireless trunk network root node through a set of wireless trunk network relay nodes, wherein wireless communications between the root node and the MDP include wireless multiple-input multiple-output (MIMO) transmissions;
a plurality of access points coupled to the MDP and forming a wireless distribution network capable of providing broadband wireless service to stations on the wireless distribution network, wherein wireless communications between the MDP and the APs include wireless MIMO transmissions.

2. The system of claim 1 further comprising at least one wireless trunk relay node, wherein, in operation, the at least one wireless trunk relay node transmits point-to-point wireless MIMO upstream toward the root node and downstream toward the MDP.

3. The system of claim 1, wherein MPD to AP transmission includes point-to-multipoint MIMO.

4. The system of claim 1, wherein a radio device on the MDP includes at least one generic modular unit that can be swapped in or out to handle wireless traffic load.

5. The system of claim 1, wherein radio devices on the APs include at least one generic modular unit that can be swapped in or out to handle wireless traffic load.

6. The system of claim 1, wherein radio devices on the wireless trunk relay nodes include at least one generic modular unit that can be swapped in or out to handle wireless traffic load.

7. The system of claim 1, wherein a first AP of the APs includes an AP antenna array and a mesh relay antenna array, wherein, in operation:
the first AP transmits and receives via the AP antenna array wireless communications between the AP and stations within range of the AP;
the first AP receives wireless transmissions from a second downstream AP via the mesh relay antenna array and forwards wireless communications from the stations within range of the AP and from the second downstream AP via wireless MIMO backhaul to a third AP or the MPD.

8. A method comprising:
coupling a point of presence (PoP) on a network to a main distribution point (MDP) of a wireless distribution network via a wireless trunk network;
forming a mesh network in the wireless distribution network using a plurality of access points (APs);
employing multiple-input multiple-output (MIMO) wireless backhaul from the farthest of the APs from the MDP to the nearest of the APs to the MDP, and continuing the MIMO wireless backhaul through the MDP to the PoP;
providing broadband wireless service to a station within range of at least one of the APs.

9. The method of claim 8 wherein the MIMO wireless backhaul includes point-to-point MIMO.

10. The method of claim 8 wherein the MDP to AP transmission includes point-to-multipoint MIMO.

11. The method of claim 8 further comprising beamsteering with multiple antennas.

12. The method of claim 8 further comprising using each of multiple antennas at the MDP for different spatial channels.

13. The method of claim 8 further comprising:
mounting the APs on poles;
spacing the poles to provide wireless broadband to a geographic area.

14. The method of claim 8, further comprising implementing radio devices on the APs and MDP with generic modular units, wherein generic modular units can be swapped in or out to handle wireless traffic load.

15. A system comprising:
a first multiple-input multiple-output (MIMO) wireless access point (AP) including:
an AP antenna array having a plurality of antennas;
a mesh relay antenna array having a plurality of antennas;
a radio coupled to the plurality of antennas;
wherein, in operation:
the MIMO wireless AP is mounted along with a second MIMO wireless AP to form a wireless mesh network over an area;
the radio receives wireless communications from further upstream and determines whether to transmit the wireless communications to a station within range of the AP antenna array, whether to forward the wireless communications to the second MIMO wireless AP further downstream via the mesh relay antenna array, or both;
the radio receives wireless communications from the stations within range of the AP antenna array via the AP antenna array and receives wireless communications from the second MIMO wireless AP and forwards the wireless communications further upstream via wireless MIMO backhaul via the mesh relay antenna array.

16. The system of claim 15, wherein the mesh relay antenna array includes a downstream receive antenna subarray, a downstream transmit antenna subarray, an upstream receive antenna subarray, and an upstream transmit antenna subarray.

17. The system of claim 15, further comprising a solar cell coupled to the first MIMO wireless AP and the second MIMO wireless AP.
